(19) United States
(12) Patent Application Publication
(10) Pub. No.: US 2008/0216989 A1
(43) Pub. Date: Sep. 11, 2008

(54) WELD BEAD REINFORCEMENT OF CHARGE AIR COOLER HEADERS AND METHOD OF MAKING SAME

(75) Inventor: Harold A. Grajzl, Summerville, SC (US)

Correspondence Address: LEYDIG VOIT & MAYER, LTD, 700 THIRTEENTH ST. NW, SUITE 300, WASHINGTON, DC, 20005-3960, US

(73) Assignee: Behr America Inc., Troy, MI (US)

(21) Appl. No.: 11/683,188

(22) Filed: Mar. 7, 2007

(51) Int. Cl. B23K 31/02

(52) U.S. Cl. 165/76; 228/183; 165/906

(57) ABSTRACT

A fracture-resistant charge air cooler header is provided. The internal side of the header includes, at select locations most likely to sustain a fracture, a reinforcing weld bead or “nugget” of sufficient height to create a section modulus change. The weld bead is preferably formed from a highly ductile alloy, such as AA 1100 aluminum alloy, and may surround either a portion of the header component associated with a tube or its entire perimeter.

### FIELD OF THE INVENTION

The present invention relates to a heat exchanger in general, and a weld bead reinforced charge air cooler header in particular. The present invention also relates to a method for making such a heat exchanger in an efficient manner. A heat exchanger including a charge air cooler header made according to the present invention may be particularly advantageous for use in heavy duty trucks and other similar vehicles.

### BACKGROUND OF THE INVENTION

Charged air technologies, e.g., use of a turbocharger, can increase engine efficiency while simultaneously decreasing undesirable emissions. The process of charging air through a turbocharger results in an increase in temperature of the charged air. Aftercoolers or charge air coolers are heat exchangers, typically air-to-air heat exchangers, that use ambient or outside air to cool engine intake air after it has passed through a charging device but before it enters an engine's combustion chambers. Cooler fuel/air mixtures burn more efficiently with significantly reduced emissions than charged air that is not cooled. Appropriate air charging, when coupled to air-to-air cooling devices, can substantially increase an engine's power density with little or no increase in its physical dimensions or reduction in its life-before-overhaul expectancy.

Charge air coolers typically consist of bundles of flat tubes fluidly connected to header components via ferrules. Charged air flows inside the flat tubes while outside air passes across fins of the charge air cooler to thereby cool the charged air.

Charge air coolers, however, are exposed to high thermal and environmental stresses. These conditions have been known to cause fractures in the header components and ferrules, particularly in a transverse direction to the header. FIG. 1 is a perspective view of a first cross-section 1 and a second cross-section 2 of a damaged charge air cooler. The first cross-section illustrates a portion of a tube-containing block 2 as well as a flat tube 3 coupled to a ferrule 4. The second cross-section illustrates a different portion of the tube-containing block 2 as well as a second ferrule 7. Cross-sections 1 and 2 illustrate representative fractures 5 and 8 in the ferrules of the charge air cooler. These fractures cause decreased operating efficiency of the charge air cooler or even result in a completely inoperative condition.

A need therefore exists for an aftercooler containing header components and flat tubes that can withstand the high thermal and environmental stresses placed upon them without fracturing, particularly under heavy duty conditions.

### SUMMARY OF THE INVENTION

The invention is generally directed to a heat exchanger for a motor vehicle, such as an aftercooler, that includes a reinforcing weld bead or “nugget” applied to header components coupled to the charge air cooling tubes. The weld bead metallurgically modifies the internal side of the header with a ductile aluminum alloy, thereby delaying or preventing fracture initiation.

In a preferred embodiment, the reinforced weld bead is applied only to selected header portions, i.e., the weld bead is applied only to the header portions most likely to fracture under stress. In this embodiment, the weld bead further is applied only to internal header portions. In one embodiment of the invention, the weld bead completely surrounds the perimeter of the header component associated with a tube. In a different embodiment, the weld bead is applied only to one or both of the “nose” areas of the header components associated with a tube. As yet another aspect of certain embodiments of the invention, the weld bead is physically separate from the tube during assembly of the heat exchanger to insure the purity of the weld bead chemistry.

In a further preferred embodiment, the weld bead is formed from an AA 1100 aluminum alloy (the “AA” designation refers to the Aluminum Association Inc., which specifies the composition of standard aluminum alloys) or similarly pure alloy. The weld bead is formed to a minimum height to create a section modulus change.

Further objects, features and advantages of the invention, will become apparent from the detailed description of the preferred embodiments that follows, when considered in conjunction with the attached figures of drawing.

### BRIEF DESCRIPTION OF THE DRAWINGS

Exemplary embodiments of the invention are given below with reference to the drawing, in which:

FIG. 1 is a perspective view of two cross-sections of a damaged charge air cooler;

FIG. 2 is a top view of an aftercooler that illustrates the exemplary failure locations of tubes;

FIG. 3 is a cross-sectional view of a fracture area that illustrates the propagation direction of the fracture;

FIG. 4 is a cross-sectional view of a header and tube interface that illustrates a weld bead according to the present invention on the internal side of a header;

FIG. 5 is an exploded view of a weld bead on the internal side of the header;

FIG. 6 is an alternate exploded view of a weld bead on the internal side of the header;

FIG. 7 is a perspective view of a charge air cooler header that includes tubes both above and below the header internal surface;

FIG. 8 is a perspective view of a charge air cooler header that includes a weld bead applied to the nose portions of a header at selected tube locations; and

FIG. 9 is a perspective view of a charge air cooler header that includes a weld bead applied to the complete perimeter of the header at selected tube locations;

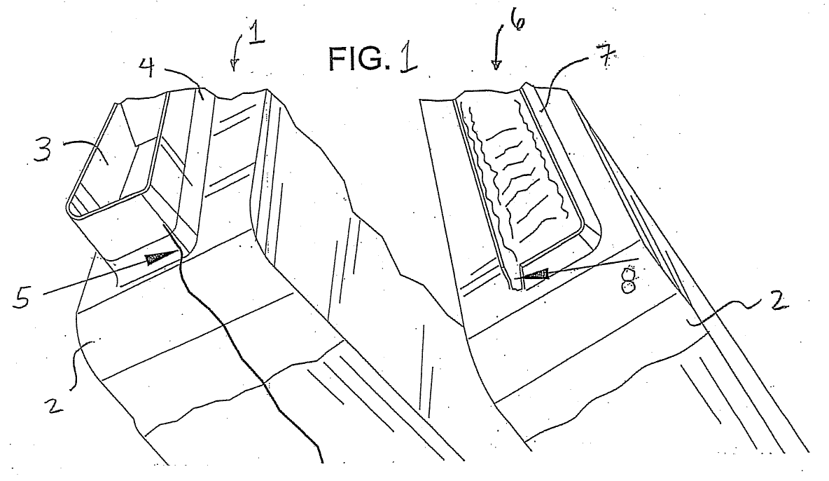

### DETAILED DESCRIPTION OF PREFERRED EMBODIMENTS

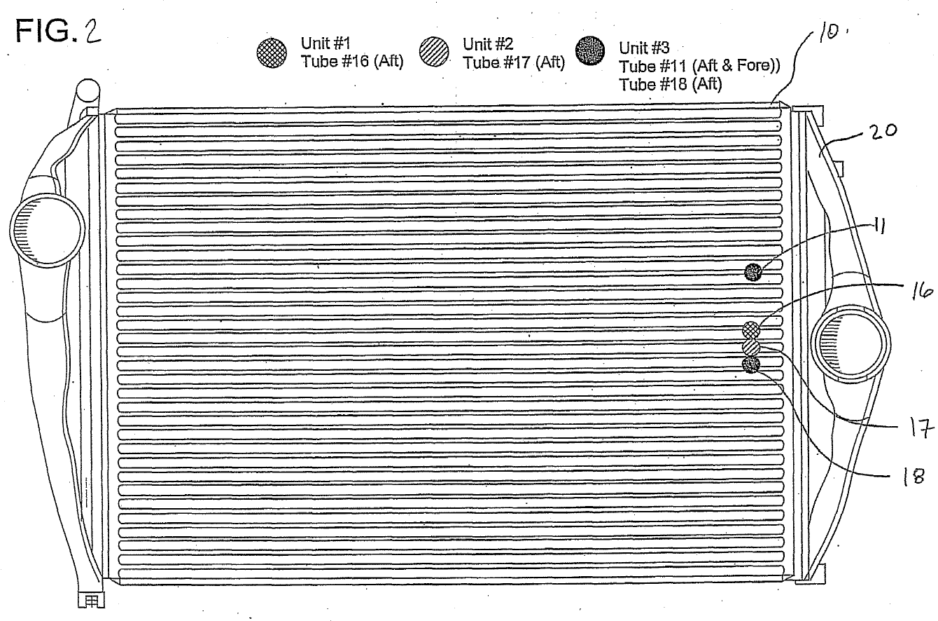

Field experience confirms that fractures associated with header components in charge air coolers do not occur with equal frequency at all tube locations. FIG. 2 illustrates the locations of exemplary header failures for three separate charge air cooler units, generally illustrated at reference numeral 10. In a first unit, the charge air cooler sustained fractures in the header's aft location of the 16^{th} tube of a 33 tube unit, illustrated at reference numeral 16; the second unit sustained fractures in the header's aft location of tube 17, illustrated at reference numeral 17; and the third unit sustained fractures in the headers' fore and aft locations of tube 11, illustrated at reference numeral 11, and the aft location of tube 18, illustrated at reference numeral 18.

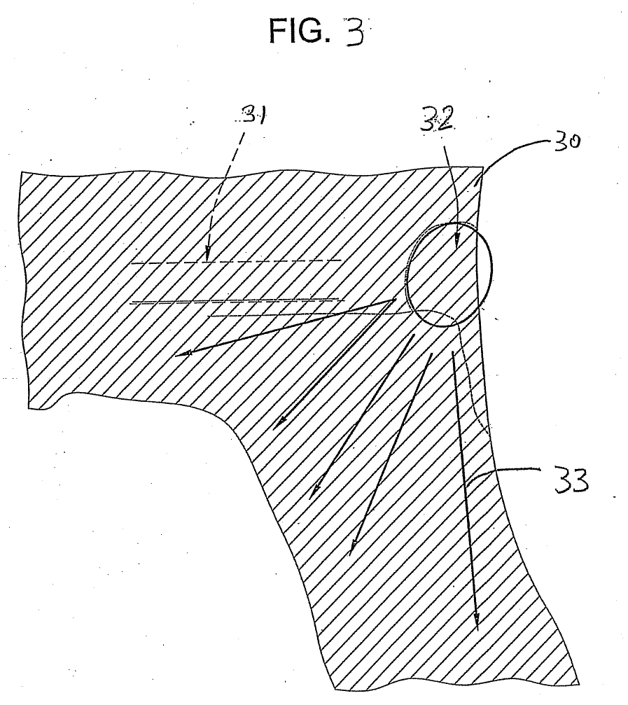

FIG. 3 illustrates a magnified cross section of a header component 30 that has sustained a fracture. During the assembly process of a charge air cooler, a tube (indicated by dashed lines 31) is brazed to the header. Filler metal in a region generally indicated by circle 32 completes the bond between the tube and the header component. In the absence of the invention, stressful conditions may initiate a fracture in the filler metal at the internal side of the header. Microscopic inspection of such fractures reveals coarse striation, which indicates that the failure mode is a high stress, low cycle fatigue. Arrows 33 generally illustrate the propagation of the fracture from the filler metal region 30. The fractures are typically caused by a high difference in temperature.

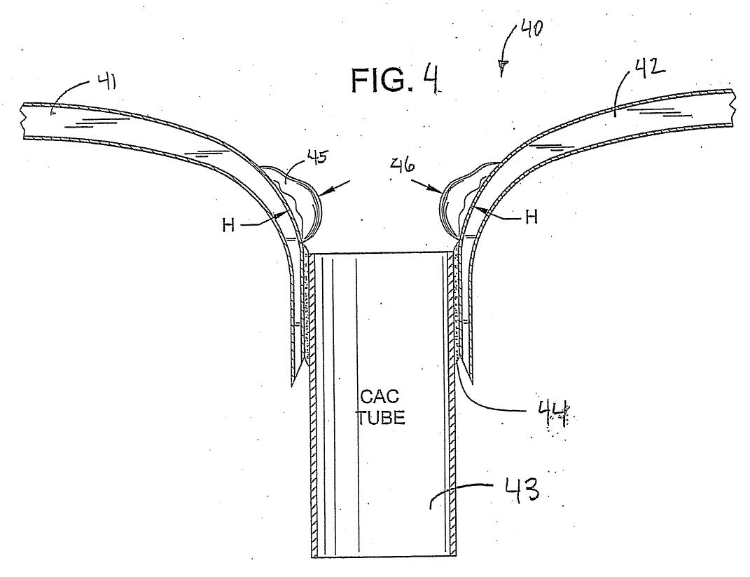

To arrest or at least delay the onset of such fractures, an embodiment of the present invention includes the application of a reinforcing weld bead to the internal side of header components that interface with charge air cooler tubes. FIG. 4 is a cross sectional view that illustrates a header-tube interface, generally indicated by reference numeral 40. Header components 41 and 42 connect with a charge air cooler tube 43. In a manner known to those of skill in the art, the tube 43 is brazed to the header components. Filler metal 44 completes the bond between tube 43 and header components 41 and 42.

Weld beads 45 and 46 are applied to the internal side of header components 41 and 42. The height of weld beads 45 and 46, designated by the letter “H,” create a section modulus change in the header that retards and/or eliminates header ferrule fractures. Weld beads 45 and 46 further promote longer header durability. Weld beads 45 and 46 may be applied in a manner known to those skilled in the art, including through the use of TIG (GTAW) welding processes.

In a preferred embodiment, the reinforcing weld beads are comprised of highly pure and ductile aluminum. For example, AA 1100 aluminum alloy may be used. This alloy is approximately 99% aluminum and has exceptional ductility when compared with other alloys.

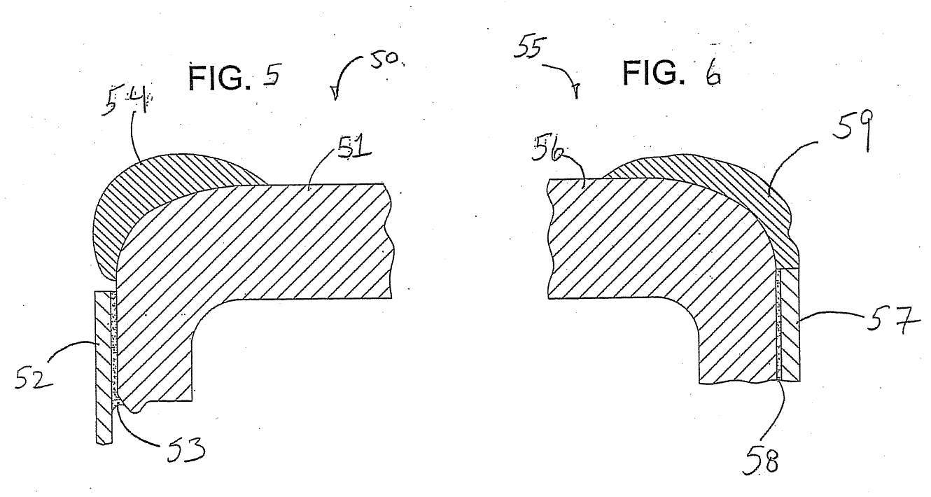

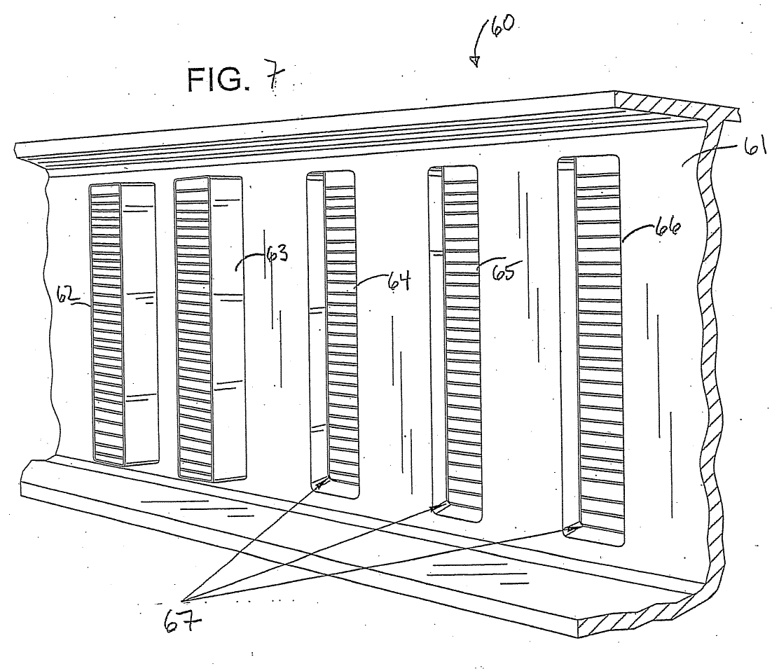

FIGS. 6 and 7 comparatively illustrate the differences between weld beads applied to the internal side of header components. FIG. 5 illustrates a portion of a tube-header interface 50 in which a header component 51 is bonded to a tube wall 52 through filler metal 53. A weld bead 54 also has been applied to the internal portion of the header 51. FIG. 6 likewise illustrates a header-tube interface 55 in which a header component 56 is bonded to a tube wall 57 through filler metal 58. A weld bead 59 also has been applied to the internal portion of the header 56. As is evident, weld beads 54 and 59 both impart a section modulus change to their respective header components.

Although either embodiment may reduce or prevent fracturing of the header components, the weld bead 54 illustrated in the embodiment of FIG. 5 is particularly advantageous because it avoids contact with either tube wall 52 or filler metal 53. In this embodiment, neither the tube alloy nor the filler metal is consumed into the weld bead 54. Weld bead 54 is thus more pure than weld bead 59, and, because the tube alloy is typically a less ductile aluminum alloy, such as an AA 3000 series alloy, weld bead 54 retains its superior ductility at or near possible fracture sites when compared with weld bead 59.

FIG. 7 illustrates an arrangement of header components and tubes prior to the application of a reinforcing weld bead. Tubes 62-66 connect to a header 61. Tubes 62 and 63 are arranged in a conventional manner in which the tops of the tubes extend beyond the header interface. In contrast, tubes 64, 65 and 66 remain below the header internal surface, as illustrated by reference numeral 67. By maintaining this latter arrangement of tubes, it is possible to apply a weld bead, such as weld bead 54 of FIG. 5, to the header component without such bead consuming the tube alloy or filler metal.

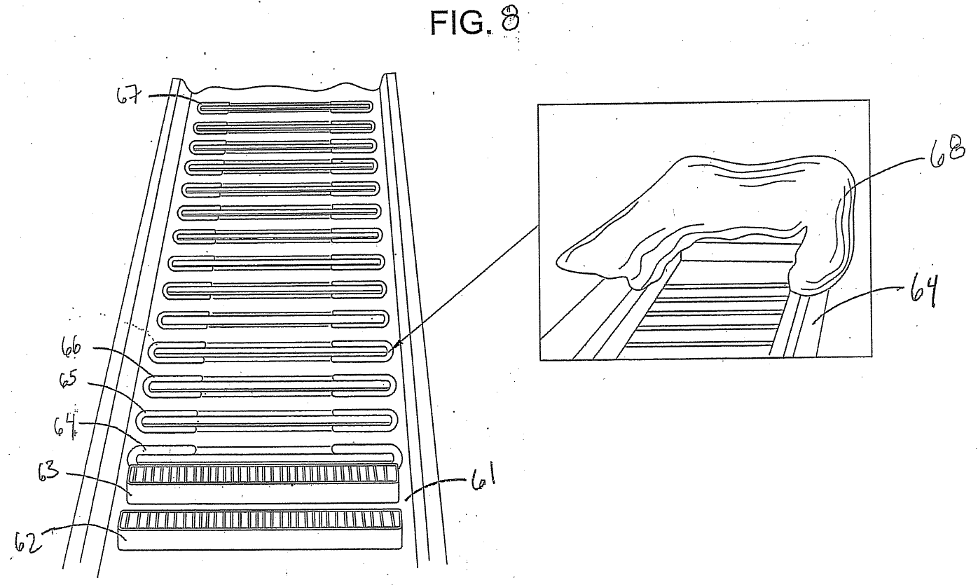

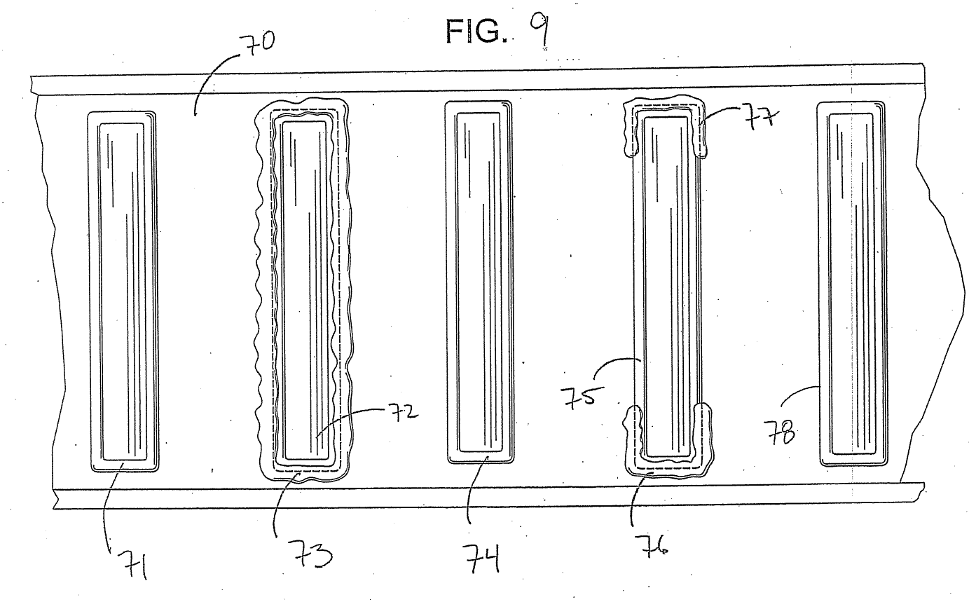

FIG. 8 is a perspective view that illustrates a weld bead as applied to select header-tube interfaces. It is an aspect of one embodiment of the invention that a reinforcing weld bead is applied to only select header components, thereby saving on material and manufacturing costs. In the embodiment of FIG. 8, a weld bead is selectively applied only to the fore and aft nose section of the header for those header-tube interfaces most likely to sustain fractures. For those header-tube interfaces that are less likely to sustain a fracture, the tubes, such as tubes 62 and 63, may protrude above the internal header. It will be appreciated by persons of skill in the art that the “nose” section is the area around the fore and aft ends of the tube. FIG. 8 further includes an enlarged sectional view of a weld bead 68 on a header for a recessed tube 64.

Other possible reinforcing weld beads and combinations thereof are possible. FIG. 9, for example, illustrates the selective application of reinforcing weld beads to header 70 of a charge air cooler. The header portion near tubes 71, 74, and 78 do not include any section modulus changing weld beads on the header in the vicinity of the tube. In contrast, a weld bead 73 has been applied to the header 70 along the entire perimeter of tube 73 and separate weld beads 76 and 77 have been applied to the nose portions of tube 76. The need to selectively apply reinforcing weld beads will depend on the likelihood that the header portion will sustain a fracture above a particular tube. In addition, the need to apply the weld bead around the entire perimeter of a tube, such as weld bead 73, or to only the nose section of such tubes, such as weld beads 76 and 77, will likewise depend on the likelihood of failure.

While this invention has been described with an emphasis upon particular embodiments, it should be understood that the foregoing description has been limited to the presently contemplated best modes for practicing the invention. For example, the precise form of the weld bead may be modified in accordance with the invention. It will be apparent that further modifications may be made to the invention, and that some or all of the advantages of the invention may be obtained. Also, the invention is not intended to require each of the above-described features and aspects or combinations thereof. In many instances, certain features and aspects are not essential for practicing other features and aspects. The invention should only be limited by the appended claims and equivalents thereof, since the claims are intended to cover other variations and modifications even though not within their literal scope.

What we claim is:

1. A heat exchanger suitable for use as a charge air cooler for a motor vehicle comprising at least one header fluidly connected to a plurality of air cooling tubes made from a first metal alloy, wherein the header includes at least one reinforcing weld bead that changes the section modulus of an internal portion of the header in an area adjacent to at least one of the air cooling tubes, and wherein the reinforcing weld bead is comprised of a second metal alloy of higher ductility than the first metal alloy.

2. A heat exchanger as claimed in claim 1, wherein the first metal alloy is an aluminum alloy.

3. A heat exchanger as claimed in claim 2, wherein the second metal alloy is an aluminum alloy.

4. A heat exchanger as claimed in claim 1, wherein the weld bead does not contact any of the plurality of air cooling tubes.

5. A heat exchanger as claimed in claim 4, wherein the plurality of air cooling tubes are bonded to the header with filler metal and wherein the at least one reinforcing weld bead does not contact the filler metal.

6. A heat exchanger suitable for use as a charge air cooler for a motor vehicle comprising at least one header fluidly intersecting with a plurality of air cooling tubes made from a first metal alloy, wherein the header includes at predetermined locations a plurality of reinforcing weld beads of greater section modulus than the header, and wherein the reinforcing weld beads are comprised of a second metal alloy of higher ductility than the first metal alloy.

7. A heat exchanger as claimed in claim 6, wherein the first metal alloy is an aluminum alloy and the second metal alloy is an aluminum alloy.

8. A heat exchanger as claimed in claim 6, wherein a reinforcing weld bead is formed on the header along the entire perimeter defined by an intersection between the header and an air cooling tube.

9. A heat exchanger as claimed in claim 8, wherein a reinforcing weld bead is formed on the header along a portion of the perimeter defined by an intersection between the header and an air cooling tube.

10. A heat exchanger as claimed in claim 6, wherein a reinforcing weld bead is formed on the header along a portion of the perimeter defined by an intersection between the header and an air cooling tube.

11. A heat exchanger as claimed in claim 10, wherein the reinforcing weld bead is formed along one of the longitudinal end portions of the perimeter.

12. A heat exchanger as claimed in claim 10, wherein an additional reinforcing weld bead is formed along the other longitudinal end portion of the perimeter.

13. A heat exchanger as claimed in claim 6, wherein a reinforcing weld bead is formed on the header at predetermined intersections between the header and air cooling tubes.

14. A heat exchanger as claimed in claim 13, wherein the predetermined intersections are all intersections.

15. A heat exchanger as claimed in claim 13, wherein the predetermined intersections are fewer than all intersections.

16. A heat exchanger as claimed in claim 15, wherein a reinforcing weld bead is formed on the header along the entire perimeter of an intersection.

17. A heat exchanger as claimed in claim 15, wherein a reinforcing weld bead is formed on the header along a portion of the perimeter of an intersection.

18. A heat exchanger as claimed in claim 17, wherein the reinforcing weld bead is formed along one of the longitudinal end portions of the perimeter.
